(19) United States
(12) Patent Application Publication
(10) Pub. No.: US 2025/0231210 A1
(43) Pub. Date: Jul. 17, 2025

(54) Semi-Automated Immunolabeling Systems and Associated Devices and Methods

(71) Applicant: University of Iowa Research Foundation, Iowa City, IA (US)

(72) Inventors: Muhammad Taifur Rahman, Iowa City, IA (US); Nashwaan A. Khan, Iowa City, IA (US); Mahmudul Alam Shakib, Iowa City, IA (US); Thilina H. Weerakkody, Iowa City, IA (US); Ibrahim Razu, Iowa City, IA (US); Marlan Hansen, Iowa City, IA (US)

(73) Assignee: University of Iowa Research Foundation, Iowa City, IA (US)

(21) Appl. No.: 19/029,665

(22) Filed: Jan. 17, 2025

Related U.S. Application Data
(60) Provisional application No. 63/621,853, filed on Jan. 17, 2024.

(51) Int. Cl. G01N 35/10; G01N 1/31

(52) U.S. Cl. CPC G01N 35/1009; G01N 1/31; G01N 35/1002; G01N 35/1067; G01N 2035/1027

(57) ABSTRACT

A device for immunolabeling comprising one or more solution containers with product drains through which fluid can flow; one or more valves capable controlling fluid flow through the product drains; and a sample container, wherein fluid flowing through the product drains flows into the sample container.

### CROSS-REFERENCES & RELATED APPLICATIONS

This application claims priority to U.S. Provisional Application No. 63/621,853 filed Jan. 17, 2024 and entitled “Semi-Automated Immunolabeling Systems and Associated Devices and Methods,” which is hereby incorporated by reference in its entirety under 35 U.S.C. § 119 (e).

### STATEMENT OF GOVERNMENT INTEREST

This invention was made with government support under DC020643 awarded by the National Institutes of Health. The government has certain rights in the invention.

### TECHNICAL FIELD

The disclosed technology relates to semi-automated immunolabeling systems (SAILS), which was developed with the aim of automating immunolabeling techniques for basic scientific research.

### BACKGROUND

Immunolabeling is a process in which slides containing tissue samples are chemically processed to prepare them for labeling/tagging with antibodies directed against specific target molecules. Immunolabeling is usually followed by microscopy and imaging techniques that enable the investigators to visualize their target molecules and cells. Laboratories throughout the world use a similar immunolabeling principle with subtle modifications of techniques. Different solutions are applied to the sample which is followed by the application of antibodies. Application of these solutions is a repetitive, tedious process. The semi-autonomous immunolabeling system, “SAILS”, aims to automate the first part of immunolabeling, as it relates to devices, systems and methods, to apply different solutions to tissue in a timely fashion and prepare it for labeling with an antibody or antibodies. Since the system is programmed with certain defined times or parameters, these can be adjusted to meet various protocols for immunolabeling. Comparing SAILS to existing solutions, it is comparatively cheaper and more suitable for use in small experimental laboratories while existing solutions are expensive and intended for industrial applications.

There are two existing solutions for immunolabeling: manual immunolabeling and fully automated immunolabeling devices. Manual immunolabeling is a tedious, labor-intensive process. While the currently available automated options are prohibitively expensive, as they cost nearly $100,000 or more. Because most laboratories cannot afford the automated options, their use is limited to industrial setups. The operating cost for automated devices is very high as well: using these devices results in the use of large amounts of expensive antibodies, as there is little control over the antibody application step.

The labor cost of manual immunolabeling is potentially as expensive as industrial machines, when examined over long time periods. Roughly, 20% of the working hours of a research assistant is spent on immunohistochemistry, costing ˜$10,000 per year. Additionally, costs associated with training of new personnel and periodic retraining of existing personnel is added to this number. As the disclosed SAILS system is semi-automated, it provides improved consistency, reduced human error, reduced labor costs, and reduced training costs, among various other improvements.

### BRIEF SUMMARY OF THE INVENTION

The disclosed system, sometimes referred to as a semi-autonomous immunolabeling system, or “SAILS”, relates to devices, systems and methods that automate steps of the immunolabeling process, making the overall process less labor intensive and cheaper. The disclosed system uses a configuration of reservoirs and valves to perform the washing and blocking steps of the immunolabeling process.

In Example 1, semi-automated immunolabeling system, comprising one or more solution containers, a sample container, one or more valve units configured for controlling fluid flow from the one or more solution containers and the sample container, and a control unit in operational communication with and configured to command the one or more valve units to facilitate the flow of fluid to and from the sample container.

Example 2 relates to the device of Examples 1 and 3-8, further comprising a slide cassette disposed in the sample container, wherein the system is configured to apply one or more of: at least one washing solution, a blocking solution, at least one antibody solution and at least one staining solution to the sample container via fluidic communication between the one or more solution containers and the sample container via the one or more valve units as commanded by the control unit.

Example 3 relates to the device of Examples 1-2 and 4-8, further comprising a plurality of slides vertically oriented within the slide cassette.

Example 4 relates to the device of Examples 1-3 and 5-8, further comprising a support frame and tubing.

Example 5 relates to the device of Examples 1-4 and 6-8, further comprising a user interface in electronic communication with the control unit.

Example 6 relates to the device of Examples 1-5 and 7-8, further comprising a waste drain in the sample container.

Example 7 relates to the device of Examples 1-6 and 8, further comprising a waste container.

Example 8 relates to the device of Examples 1-7, wherein each of the one or more valve units comprises a valve and actuator.

In Example 9, a method of immunolabeling a sample, via an automatic immunolabeling device comprising one or more solution containers, a sample container, one or more valve units configured for controlling fluid flow from the one or more solution containers and the sample container, and a control unit in operational communication with and configured to command the one or more valve units to facilitate the flow of fluid to and from the sample container, the method comprising: blocking the sample with a blocking solution via the automatic immunolabeling device, applying at least one antibody to the sample automatic immunolabeling device, and staining with the sample automatic immunolabeling device.

Example 10 relates to the method of Examples 9 and 11-14, further comprising washing the sample using the automatic immunolabeling device.

Example 11 relates to the method of Examples 9-10 and 12-14, wherein the washing of the sample is done in triplicate.

Example 12 relates to the method of Examples 9-11 and 13-14, wherein the method is performed over two days.

Example 13 relates to the method of Examples 9-12 and 14, further comprising a user interface in communication with the control unit.

Example 14 relates to the method of Examples 9-13, wherein the automatic immunolabeling device further comprises a user interface in electronic communication with the control unit.

In Example 15, a system for partially automated immunolabeling comprising: one or more solution containers, a sample container, a slide cassette removably disposed within the sample container and configured for containing at least one sample, a plurality of valve units each comprising a valve and an actuator and configured for controlling fluid flow from the one or more solution containers and the sample container, and a control unit in operational communication with and configured to command the one or more valve units to facilitate the flow of fluid to and from the sample container.

Example 16 relates to the device of Examples 15, and 17-20, wherein the one or more solution containers, sample container, slide cassette and plurality of valve units are in fluidic communication via tubing.

Example 17 relates to the device of Examples 15-16, and 18-20, wherein the system is configured for blocking the at least one sample with a blocking solution, applying at least one antibody to the at least one sample, staining the at least one sample, and washing the at least one sample.

Example 18 relates to the device of Examples 15-17, and 19-20, wherein the washing the at least one sample is performed between the blocking the at least one sample, the applying at least one antibody to the at least one sample and the staining the at least one sample.

Example 19 relates to the device of Examples 15-18, and 20, wherein the applying at least one antibody to the at least one sample comprises applying a primary antibody and applying a secondary antibody.

Example 20 relates to the device of Examples 15-19, wherein the system is configured to apply one or more of: at least one washing solution, a blocking solution, at least one antibody solution and at least one staining solution to the sample container and slide cassette via fluidic communication between the one or more solution containers and the sample container via the one or more valve units as commanded by the control unit.

According to certain Examples, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Other implementations of these Examples include corresponding computer systems, apparatus, and computer programs recorded on one or more computer storage devices, each configured to perform the actions of the methods.

Implementations of the described Examples and associated techniques may include hardware, a method or process, or computer software on a computer-accessible medium.

### BRIEF DESCRIPTION OF DRAWINGS

FIG. 1A is an isometric view of the immunolabeling system, according to one implementation.

FIG. 1B is a diagram of the immunolabeling system, according to one implementation.

FIG. 2A is an isometric view of a slide cassette, according to one implementation.

FIG. 2B is a cutaway view of a slide cassette, according to one implementation.

FIG. 3A is a view of a user interface, according to one implementation.

FIG. 3B is a view of a control unit, according to one implementation.

FIG. 4A is a flowchart of the immunolabeling system, according to one implementation.

FIG. 4B is a flowchart of the immunolabeling system split by day, according to one implementation.

FIG. 4C is a flowchart of the immunolabeling system processes of day 1, according to one implementation.

FIG. 4D is a flowchart of the immunolabeling system processes of day 2, according to one implementation.

### DETAILED DESCRIPTION

The disclosed technology relates to semi-automated immunolabeling systems (“SAILS”) including related devices and methods. According to certain implementations, SAILS 10 allows for certain automating immunolabeling techniques for use in basic scientific research, as would be readily understood.

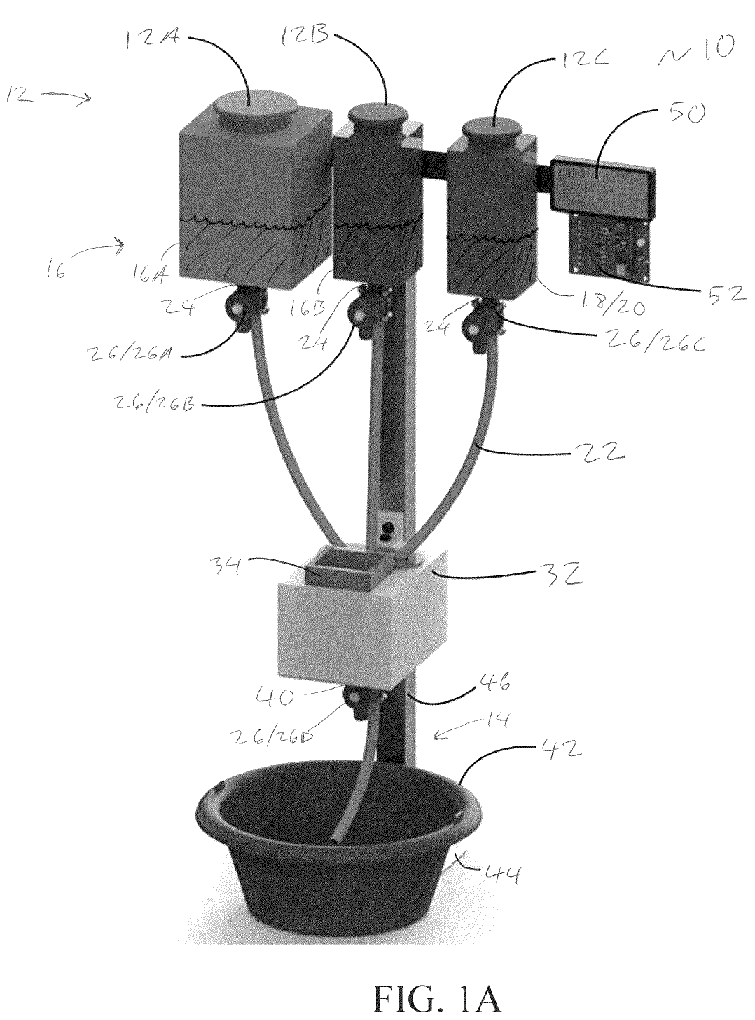

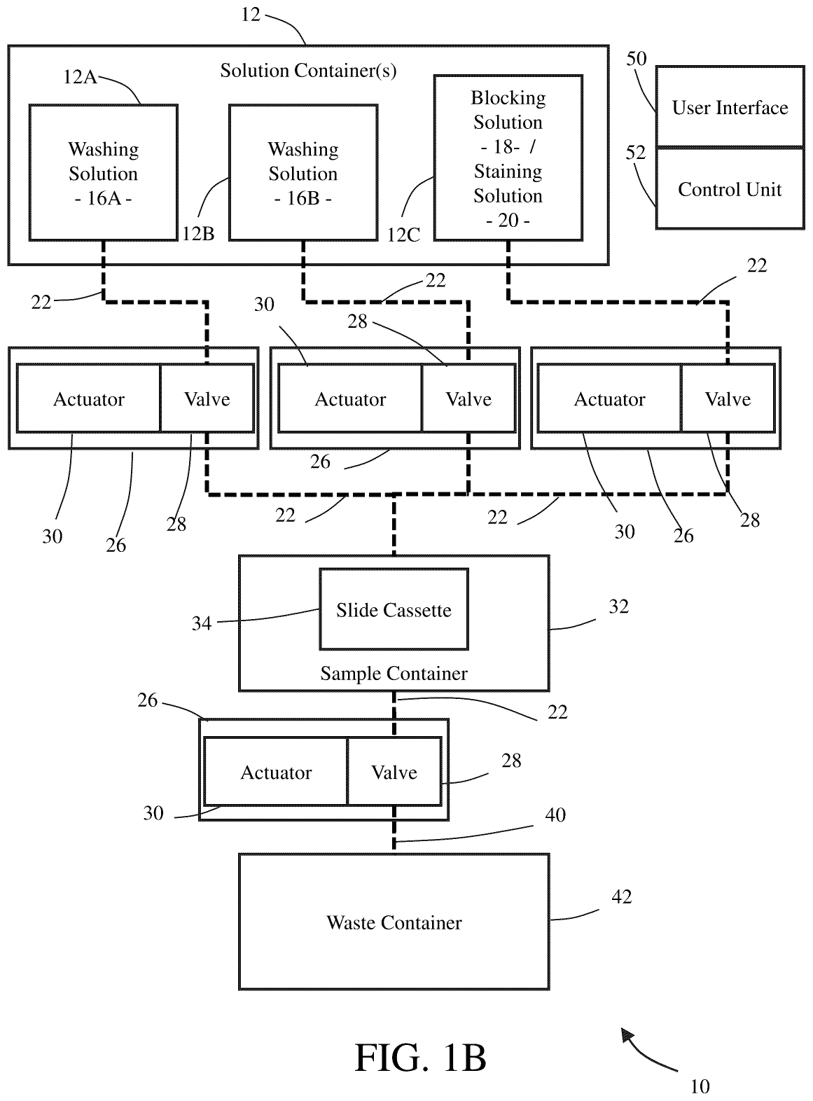

The system 10 or SAILS 10, according to various implementations, is shown generally in FIGS. 1A-B.

As shown in these implementations, the SAILS system 10 or SAILS 10 can have one or more solution containers 12, such as three solution containers 12A, 12B, 12C optionally disposed on a support frame 14. As would be readily apparent to those of skill in the art, there can be more or fewer than three solution containers 12A, 12B, 12C provided depending upon the specific needs of the procedure.

In addition to the antibodies' specificity, optimal immunolabeling depends on obtaining a good signal-to-noise ratio. Certain antibodies tend to bind nonspecifically to unrelated epitopes, resulting in undesired background staining. Thorough washing after each immunostaining step ensures the removal of nonspecifically bound antibodies. Washing buffers or solutions remove loosely bound antibodies providing a cleaner background staining.

Exemplary washing buffers 16 or solutions 16 are typically prepared using buffered saline solution. Phosphate Buffer Saline (PBS) and Tris Buffer Saline (TBS) are the most commonly used saline solutions. Depending on the experiments, appropriate permeabilizing agents are mixed at different concentrations with buffered saline solutions to make washing buffers. Permeabilizing agents include organic solvents (e.g., methanol, acetone) and detergents (Triton X-100, Tween-20, Saponin, Digitonin). Further formulations and components would of course be readily apparent to the skilled artisan.

Returning to the drawings, in certain implementations of the system 10 like that of FIG. 1A, one or more of the containers 12A, 12B, 12C can optionally contain a washing solution 16. For example, in one exemplary implementation, a first washing solution 16A and a second washing solution 16B are stored in two of the containers 12A, 12B, so as to provide the ability to separately store and provide washing solutions 16A, 16B at various points in the process. Certainly, the first washing solution 16A and second washing solution 16B in these implementations can be the same washing solution 16 or different washing solutions 16, and in certain implementations the washing solution 16 can be stored in a single container 12 that is in fluidic communication with any necessary downstream reservoirs or containers, such as the sample container 32, as would be readily appreciated.

In certain implementations, any other equivalent solution known in the art can be stored in any of the containers 12. For example, one or more of the solution containers 12 can hold a blocking solution 18 or a staining solution 20, as would be understood. Further solutions that would be readily apparent in the art can also be stored. As is also explained herein, the various containers can hold different kinds of solutions in different phases of the process.

Blocking solutions 18 are used in immunolabeling techniques to minimize non-specific antibody binding, preventing binding of antibodies to unintended sites on the tissue or cell sample. This reduces background leading to more accurate imaging results. A blocking solution 18 for immunofluorescence can be made by mixing washing buffers with serum or protein blockers.

As would also be understood, in certain implementations using blocking solution 18, the blocking solution 18 can be a saline solution, such as but not limited to a tris-buffered saline solution or phosphate buffered saline solution, containing a permeabilizing agent or detergent, such as but not limited to Triton X-100 or Tween-20, and a protein that acts as an immunolabeling blocking agent, such as but not limited to bovine serum albumin or goat serum. Various serums can be used, such as various concentrations of (e.g., 1%, 5% v/v) serum from the species that the secondary antibody was raised in. For example, Albumin and IgG from serum will bind to sticky sites on the sample preventing non-specific antibody binding. Various protein blockers can also be used, as would be readily understood, for example bovine serum albumin (BSA), casein, non-fat dry milk, or skimmed milk in a buffer are mixed at different concentrations (e.g., 1%, 3%, 5% w/v) with washing buffer to make blocking buffers. These proteins compete with the antibodies preventing non-specific binding. It would be understood in the art that many variations of composition can be used for the blocking solution 18, as would be understood.

Similarly, a staining solution 20 such as a diamidino-2-phenylindole (“DAPI”) solution 20 or similar can provide a source of fluorescence in immunolabeling application. For example, certain non-limiting examples of possible stains and dyes are Hoechst dyes, Propidium iodide (PI), the SYTOX series of dyes, the YOYO series of dyes, the NucSpot series of dyes, the DRAQ series of dyes, the BioTracker series of dyes and the like. And any similar fluorescent stain could be substituted, as would be understood.

In the specific implementation of FIG. 1A, one solution container 12A contains a first washing solution 16A, another solution container 12B contains a second washing solution 16B, and a third solution container 12C contains blocking solution 18 on day 1 and a staining solution 20 such as a DAPI solution 20 on day 2. For purposes of this implementation, this container 12C is discussed in certain examples described herein as the blocking/staining solution container 12C. Further arrangements, numbers, and configurations of containers 12 are of course possible.

In various implementations, the various solution containers 12 can be in fluidic communication with, or otherwise connected to, sections of tubing 22 through which the various fluids can flow. In various implementations, the tubing 22 can be flexible hose made of natural rubber, synthetic rubber, flexible plastics, or any material understood as appropriate in the art. In various other implementations, the tubing 22 can be rigid piping made of metal, polymers, or any material understood as appropriate in the art. In some implementations, the tubing 22 connects to the various solution containers 12 through a product drain 24 on the bottom of the solution containers 12, such that any fluid within the solution containers 12 can flow by way of gravity out of the solution containers 12 into and through the tubing 22.

As shown in FIG. 1B, in various implementations, the sections of tubing 22 are connected at one end to, and in fluidic communication with, the various solution containers 12A, 12B, 12C and on the other end are connected to and in fluidic communication with one or more valve units 26. In these implementations, these valve units 26 comprise a valve 28 and an actuator 30.

As would be understood in the art, each valve 28 can be of any configuration known in the art, such as but not limited to ball valves, gate valves, butterfly valves, globe valves, needle valves, plug valves, diaphragm valves, or others known and understood in the art. As would likewise be understood, the actuator(s) 30 are in operational communication with the valve(s) 28 and be can of any configuration known in the art, such as but not limited to manual actuators (or handles), pneumatic actuators, electric motor actuators, solenoid actuators, or others that are configured to control or otherwise actuate the operation of the corresponding valve 28 as commanded by a control unit 52, as would be readily understood and as discussed further below.

Each of the valve units 26, according to these implementations, are thereby configured to allow fluid to flow through the tubing 22 when open and disallow the flow of fluid through the tubing 22 when closed. The valves 28 can have two portions capable of coupling to the tubing 22, which can optionally be on about opposite sides of each valve 28 from one another. Optionally, the various valves 28 can be paired with an actuator 30 that is capable of opening or closing the valve 28 with which it is paired. Together, each valve 28 and actuator 30 pair make up a valve unit 26.

In various implementations, a section of tubing 22 is connected to each valve 28. Some implementations may be arranged such that the second section of tubing 22 is on the underside of each valve 28, while the first section of tubing 22 is on the topside of each valve 28. As would be understood in the art, underside and topside are general terms that are intended to be illustrative and are not intended to be restrictive or limiting to any configuration. Many other configurations can be used, as would be understood.

In various implementations, there is no section of tubing 22 between the various valves 28 and the solution containers 12, instead the various valves 28 are directly mounted to the solution containers.

In some implementations, the various second sections of tubing 22 are in fluidic communication with a sample container 32.

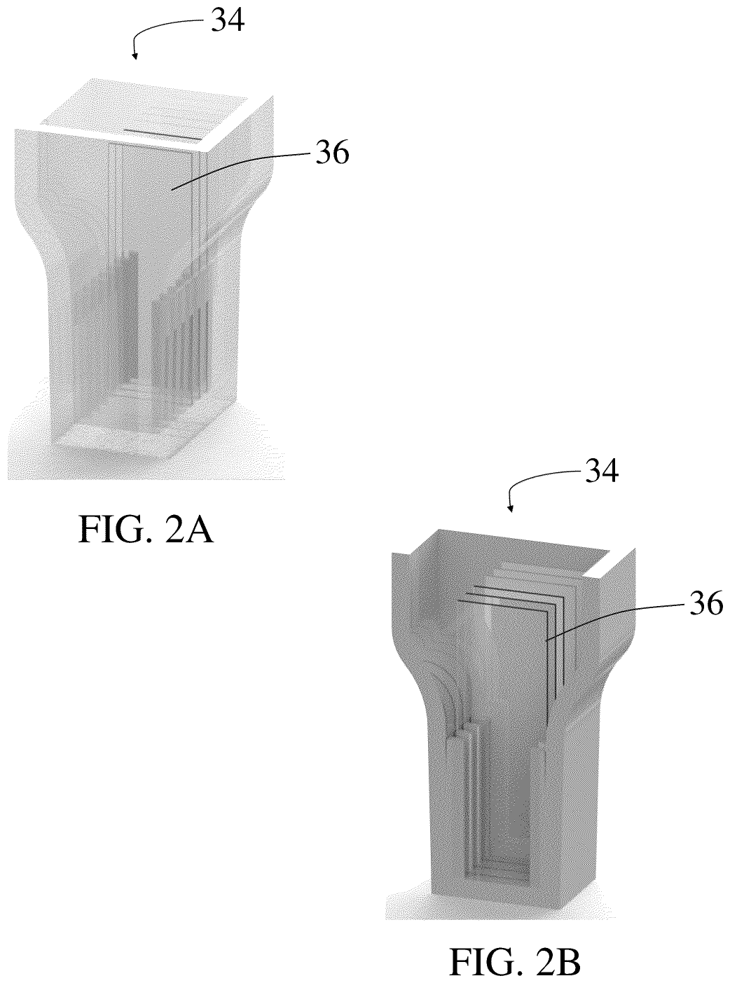

Shown in FIG. 1A, in various implementations, the sample container 32 contains a slide cassette 34. In some implementations, such as those shown in FIGS. 2A and 2B, the slide cassette 34 is shaped to contain a plurality of slides 36, optionally in a vertical orientation, with the plurality of slides 36 situated parallel to one another. As would be understood in the art, vertical is a general term that is intended to be illustrative and is not intended to be restrictive or limiting to any configuration. Many other configurations can be used, as would be understood. In various implementations, the slide cassette 34 is removable from the sample container 32, and the slide cassette 34 is configured to allow fluid poured into the sample container 32 to permeate the sample cassette 34 such that slides 36 and any samples affixed to the slides 36 can be contacted by the fluid.

In various other implementations, the sample container 32 can forgo a slide cassette 34, and instead the slides 36 with samples affixed can be inserted directly into the sample container 32.

As would be understood, the samples can be biological material, such as biological molecules, cells, tissues, or other materials that would be of interest to those in the art.

Returning to FIGS. 1A and 1B, in various implementations, the sample container 32 has a waste drain 40 such that any fluid in the sample container 32 can flow out. Optionally, this waste drain 40 may be coupled to a section of tubing 22. That section of tubing 22 may in turn be coupled to a valve unit 26, such that the valve unit 26 can allow or disallow the flow of fluid from the sample container 32. In other implementations, the valve unit 26 may be coupled directly with the sample container 32 rather than using a section of tubing 22.

In various implementations, the valve unit 26 on the drain side of the sample container 32 can be coupled to a section of tubing 22 on the underside of the valve unit 26. This section of tubing 22 can be in fluidic communication with a waste container 42. The waste container 42 is shaped such that it may retain fluid that has been discharged from the sample container 32, such as a bowl, beaker, bin, cup, or similar device.

Focusing now on FIG. 1A, in various implementations, SAILS 10 may use a support frame 14 to support various components. In some implementations, the support frame 14 can be made of a base 44, a post 46, and a crossbeam 48. In some implementations, the base 44 is a flat plate with a coupling portion disposed in about the center of the plate. The post 46 and the coupling portion of the base 44 can be configured to interlock with each other such that the post 46 is held in an about vertical orientation. The post 46 can be configured to support the crossbeam 48 at about the end opposite that coupled with the base 44. In various implementations, the crossbeam 48 can be supported by the post 46 in an about horizontal orientation.

In various implementations, the sample container 32 is secured to the post 46, the solution containers 12 are secured to the crossbeam 48, and the waste container 42 is set near the base 44. As would be understood in the art, this configuration allows fluid to flow by way of gravity from the various solution containers 12 into the sample container 32, and from the sample container 32 into the waste container 42, with this flow being interruptible through the closing of the various valves 28.

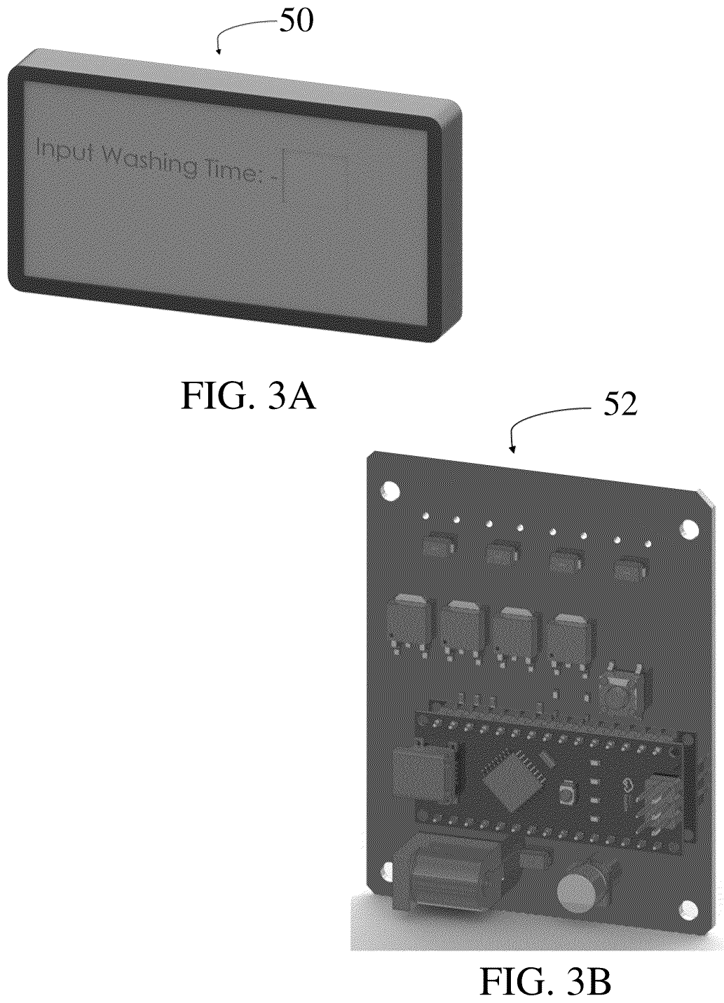

Shown in FIGS. 1A, 1B, 3A, and 3B, in various implementations, SAILS 10 can possess a user interface (“UI”) 50 and the control unit 52 that are in operational communication with the various operational components of the SAILS 10 via wired or wireless connections so as to command the various vale units 26 and other components, as would be readily understood. The UI 50 can further comprise a display 51 which can be a graphical user interface (“GUI”) and can optionally comprise a touch-screen 51. The UI 50 is configured to be in electronic communication with the control unit 52 and other components of the system 10, and to allow a user to perform various command functions, such as selecting a preprogrammed sequence of steps, as will be described below. This would be readily understood by those of skill in the art.

The control unit 52 can be any technology known in the art capable of receiving electrical input signals, creating timers, performing basic computations, and sending electrical output signals, such as those to various actuators 30. In some implementations, the control unit 52 can have a controller, such as an Arduino Uno Rev3 or such as any other controller known in the art as applicable. The control unit 52 can also have various transistors, capacitors, relays, inductors, power supply units, and other electrical control components 53 to allow the control unit 52 to maintain its power supply, send output signals of appropriate voltage and current, appropriately process input signals, and perform other necessary control functions. It is understood that the command unit 52 therefore allows for the automation of the immunolabeling processes described here.

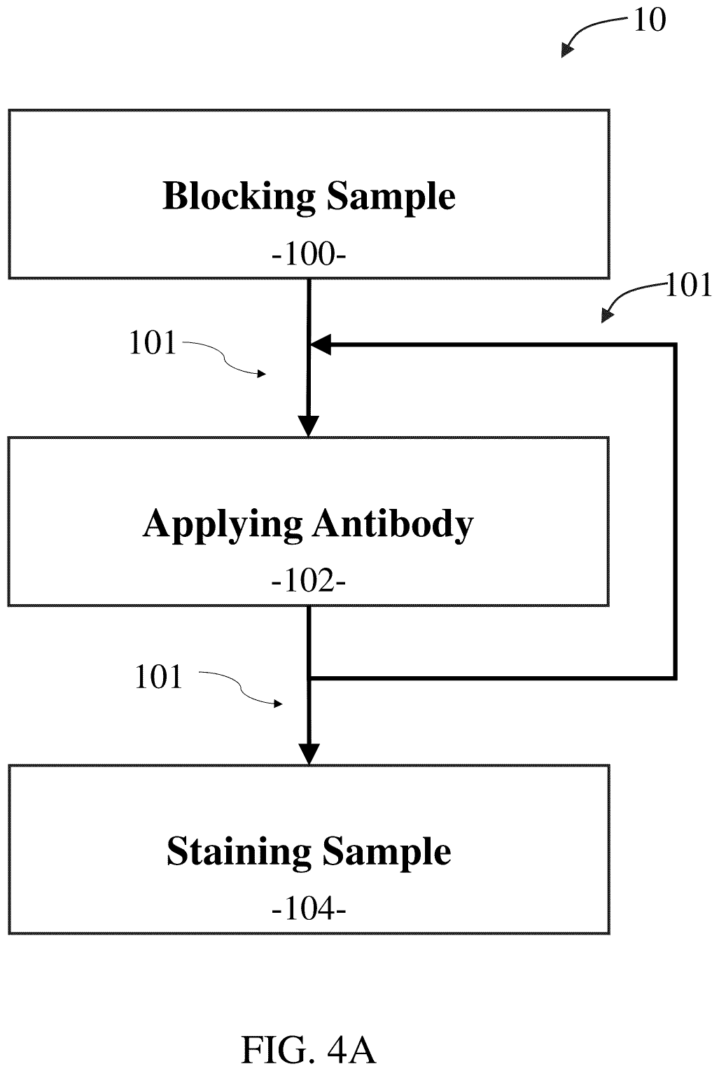

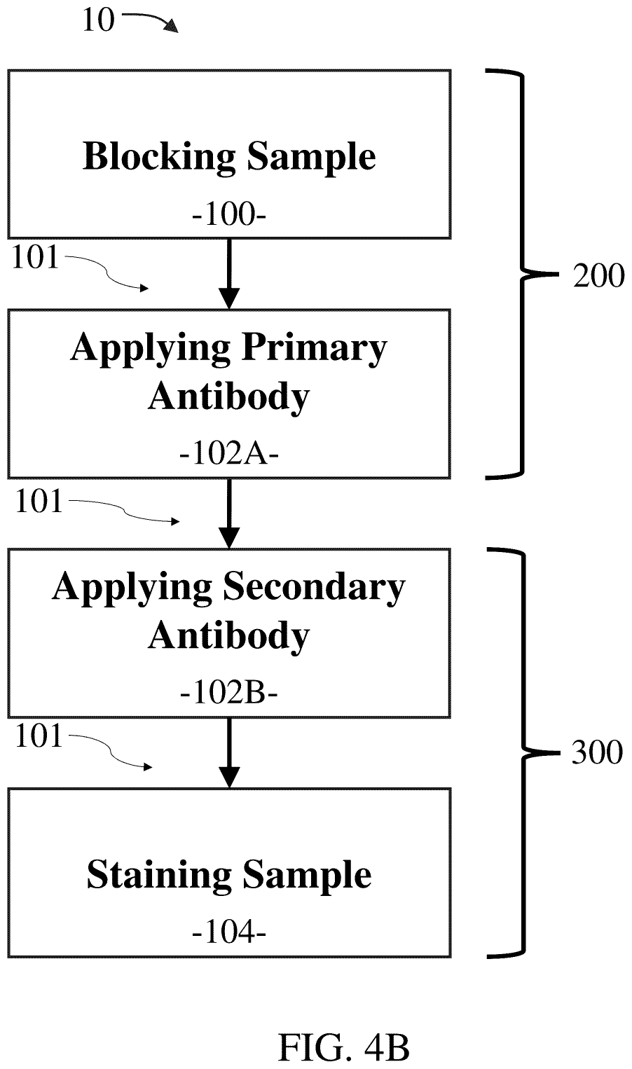

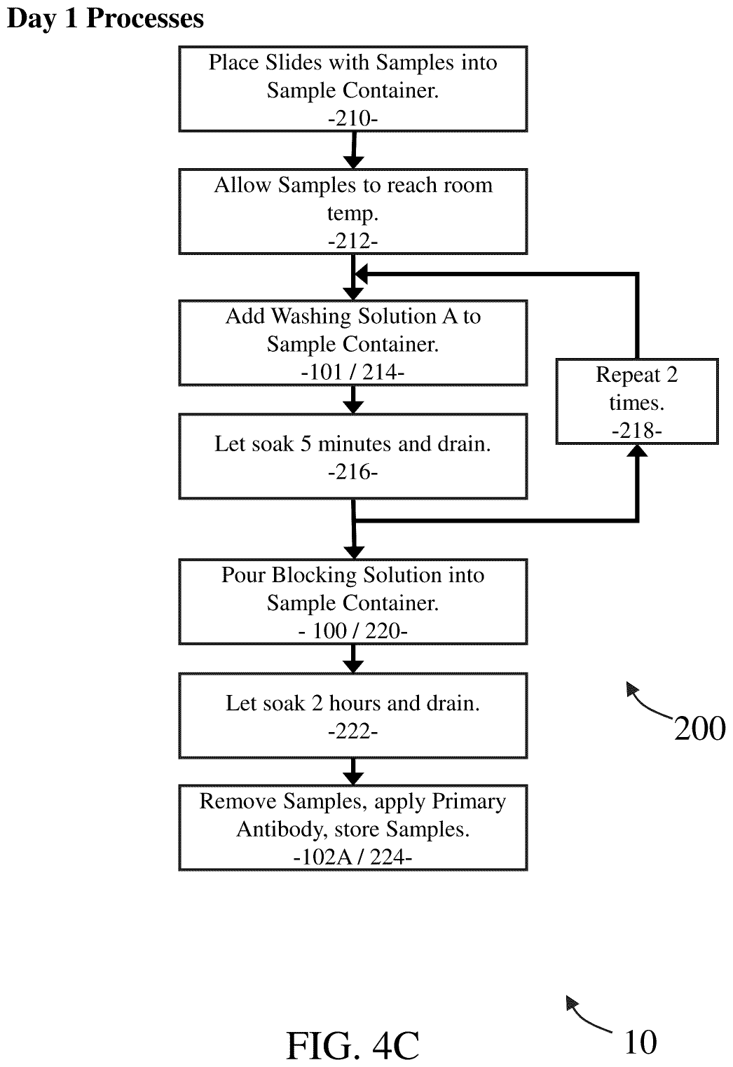

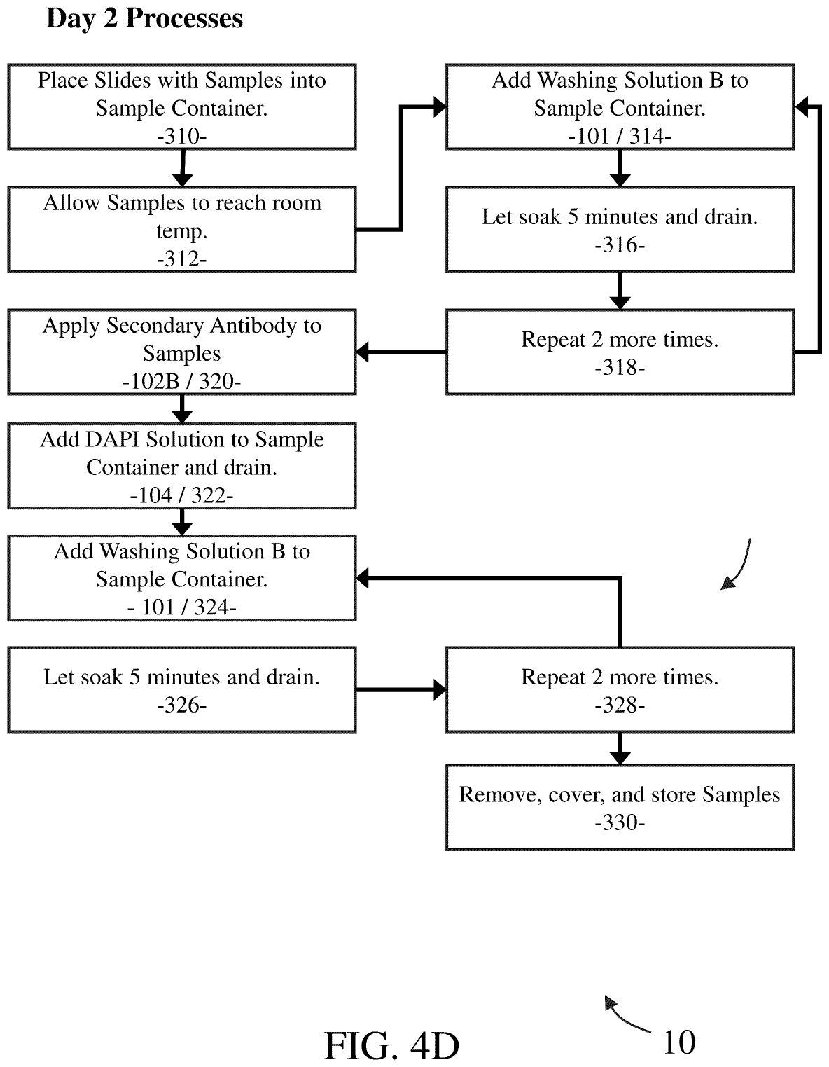

Turning now to FIG. 4A, SAILS 10 encompasses various processes that can include the steps of blocking a sample (box 100); applying an antibody to the sample (box 102), where several antibodies could be applied in an iterative fashion; and staining the sample (box 104), optionally with DAPI solution. As would be understood in the art, blocking refers to the application of a blocking solution 18, as described above, to the samples. It is understood that in these implementations, various washing steps 101 utilizing the various washing solutions 16A, 16B can be performed between the other optional steps.

According to certain implementations, SAILS 10 encompasses a multiple-day or phase process, such as the exemplary day 1 processes 200 and the exemplary day 2 processes 300 shown in FIGS. 4B, 4C and 4D. In this and similar implementations, the day 1 processes 200 include the steps of blocking a sample (box 100) and applying a primary antibody to the sample (box 102A). As would be understood, a primary antibody is one which binds to specific antigen sites on the sample. And again, it is understood that in these implementations, various washing steps 101 utilizing the various washing solutions 16A, 16B can be performed between the other optional steps. Further, certain specific blocking 100, washing 101, antibody 102A/102B and staining 103 steps are also individually discussed in these implementations, but in no way is that intended to limit them to any specific implementation.

In this and similar implementations, the day 2 processes 300 includes the steps of applying a secondary antibody to the sample (box 102B) and staining the sample (box 104). As would also be understood, a secondary antibody is one which binds to the primary antibody and can subsequently bind to a fluorescent compound, such as would be present in a staining solution like DAPI solution. Note that there is no specific requirement that day 1 processes 200 and day 2 processes 300 be performed on different days, sequential days, or under any other time constraint. As would be understood, performing day 1 processes 200 on the day before day 2 processes 300 is a custom, rather than a rule, and the processes could be performed on the same day, different days with an extended amount of time between, or according to any other schedule.

In an exemplary implementation, shown in FIG. 4C, the day 1 processes 200 may include the following steps, but other steps and step sequences could be used, as would be understood. The day 1 processes 200 can begin with placing the slides 36 into the sample container 32 (box 210). This can be done by either placing the slides 36 with samples affixed into a slide cassette 34, which is then placed into the sample container 32, or the slides 36 can be placed directly into the sample container 32. Then the samples can be allowed to sit in the sample container 32 until they reach room temperature (box 212). As would be understood, room temperature is customarily in the range of 20° C. to 25° C. The first washing solution 16A can be added to the sample container 32 (box 214).

Turning briefly to FIG. 1A, the first washing solution 16A can be added to the sample container 32 automatically by the control unit 52 sending an output command to valve unit A 26A, which in this implementation is the valve unit 26 associated with the first washing solution container 12A, to open. Back in FIG. 4C, the samples can be soaked in the first washing solution 16A for about five minutes and then the solution can be drained from the sample container 32 (box 216). Turning again to FIG. 1A, the sample container 32 can be drained by the control unit 52 sending an output command to valve unit D 26C, which is the valve unit 26 associated with the sample container 32, to open. In FIG. 4C, first washing solution 16A can be added to the sample container 32, allowed to soak for about five minutes, and drained two more times (box 218), for a total of three iterations, although more or fewer iterations are possible.

Continuing with the same exemplary implementation, the blocking solution 18 can be added to the sample container 32 (box 220). Again, turning briefly to FIG. 1A, the blocking solution 18 can be added to the sample container 32 automatically by the control unit 52 sending an output command to valve unit C 26C, which is the valve unit 26 associated with the blocking/staining solution container 12C, to open. The sample can be left to soak in the blocking solution 18 for about 2 hours, although different amounts of time are possible, after which the sample container 32 can be drained (box 222), such as by a command from the control unit 52 to valve unit D 26D through the waste drain 40 and into the waste container 42. The samples can then be removed from the sample container 32 and sample cassette 34, if used, have a primary antibody applied, and be stored, such as in a refrigerator (box 224).

FIG. 4D shows an exemplary implementation where the day 2 processes 300 include the following steps, but other steps and step sequences could be used, as would be understood. The day 2 processes 300 can begin by removing the slides 36, with attached samples, from storage and placing them into the sample container 32, either by placing them into a sample cassette 34 and placing the sample cassette 34 into the sample container 32, or by placing the samples directly into the sample container 32 (box 310). The samples can then be allowed to reach room temperature (box 312). The second washing solution 16B can then be added to the sample container 32 (box 314). Turning briefly to FIG. 1A, the second washing solution 16B can be added to the sample container 32 automatically by the control unit 52 sending an output command to valve unit B 26B, which is the valve unit 26 associated with the second washing solution container 12B, to open. Returning to FIG. 4D, the samples can be left to soak in the second washing solution 16B for about five minutes before the second washing solution 16B is drained from the sample container 32 (box 316). The second washing solution 16B can optionally be added to the sample container 32, allowed to soak for about five minutes, and drained two more times (box 318), for a total of three iterations, although more or fewer iterations are possible.

The samples can then be removed from the sample container 32 and sample cassette 34, if used, have a secondary antibody applied, before being returned to the sample container 32 (box 320). The sample container 32 can then be filled with DAPI solution, or a similar fluorescent stain, before the sample container 32 is drained (box 322). The second washing solution 16B can then be added to the sample container 32 (box 324), and the samples can soak for about five minutes before the sample container 32 is drained (box 326). The second washing solution 16B can be added to the sample container 32, allowed to soak for about five minutes, and drained two more times (box 328), for a total of three iterations, although more or fewer iterations are possible. The samples can then be removed, covered, and stored (box 330). These samples are now immunolabelled and ready for analysis.

In various implementations, the amount of fluid added to the sample container 32 is controlled automatically by the control unit 52 by keeping each valve unit 26 open for a specific amount of time. Similarly, the control unit 52 can automatically delay valve actuations to allow for various soaking steps by using internal timers, such as for about five minutes or about two hours.

Although the disclosure has been described with reference to preferred implementations, persons skilled in the art will recognize that changes may be made in form and detail without departing from the spirit and scope of the disclosed apparatus, systems, and methods.

1. A semi-automated immunolabeling system, comprising:
(a) one or more solution containers;
(b) a sample container;
(c) one or more valve units configured for controlling fluid flow from the one or more solution containers and the sample container; and
(d) a control unit in operational communication with and configured to command the one or more valve units to facilitate the flow of fluid to and from the sample container.

2. The system of claim 1, further comprising a slide cassette disposed in the sample container,
wherein the system is configured to apply one or more of: at least one washing solution, a blocking solution, at least one antibody solution and at least one staining solution to the sample container via fluidic communication between the one or more solution containers and the sample container via the one or more valve units as commanded by the control unit.

3. The system of claim 2, further comprising a plurality of slides vertically oriented within the slide cassette.

4. The system of claim 1, further comprising a support frame and tubing.

5. The system of claim 4, further comprising a user interface in electronic communication with the control unit.

6. The system of claim 1, further comprising a waste drain in the sample container.

7. The system of claim 6, further comprising a waste container.

8. The system of claim 1, wherein each of the one or more valve units comprises a valve and actuator.

9. A method of immunolabeling a sample, via an automatic immunolabeling device comprising:
(a) one or more solution containers;
(b) a sample container;
(c) one or more valve units configured for controlling fluid flow from the one or more solution containers and the sample container; and
(d) a control unit in operational communication with and configured to command the one or more valve units to facilitate the flow of fluid to and from the sample container,
the method comprising:
blocking the sample with a blocking solution via the automatic immunolabeling device;
applying at least one antibody to the sample automatic immunolabeling device; and
staining the sample with the automatic immunolabeling device.

10. The method of claim 9, further comprising washing the sample using the automatic immunolabeling device.

11. The method of claim 10, wherein the washing of the sample is done in triplicate.

12. The method of claim 9, wherein the method is performed over two days.

13. The method of claim 9, further comprising a user interface in communication with the control unit.

14. The method of claim 13, wherein the automatic immunolabeling immunolabeling device further comprises a user interface in electronic communication with the control unit.

15. A system for partially automated immunolabeling comprising:
(a) one or more solution containers;
(b) a sample container;
(c) a slide cassette removably disposed within the sample container and configured for containing at least one sample;
(d) a plurality of valve units each comprising a valve and an actuator and configured for controlling fluid flow from the one or more solution containers and the sample container; and
(e) a control unit in operational communication with and configured to command the one or more valve units to facilitate the flow of fluid to and from the sample container.

16. The system of claim 15, wherein the one or more solution containers, sample container, slide cassette and plurality of valve units are in fluidic communication via tubing.

17. The system of claim 16, wherein the system is configured for:
blocking the at least one sample with a blocking solution;
applying at least one antibody to the at least one sample;
staining the at least one sample; and
washing the at least one sample.

18. The system of claim 17, wherein the washing the at least one sample is performed between the blocking the at least one sample, the applying at least one antibody to the at least one sample and the staining the at least one sample.

19. The system of claim 18, wherein the applying at least one antibody to the at least one sample comprises applying a primary antibody and applying a secondary antibody.

20. The system of claim 15, wherein the system is configured to apply one or more of: at least one washing solution, a blocking solution, at least one antibody solution and at least one staining solution to the sample container and slide cassette via fluidic communication between the one or more solution containers and the sample container via the one or more valve units as commanded by the control unit.
